(19) United States
(12) Patent Application Publication
(10) Pub. No.: US 2025/0017245 A1
(43) Pub. Date: Jan. 16, 2025

(54) VEGAN-BASED EGG YOLK SUBSTITUTE PRODUCT

(71) Applicants: NEGGST FOODS GMBH, Berlin (DE); FRAUNHOFER-GESELLSCHAFT ZUR FÖRDERUNG DER ANGEWANDTEN FORSCHUNG E.V., Munchen (DE)

(72) Inventors: Veronica GARCIA ARTEAGA, Berlin (DE); Katrin HASENKOPF, Freising (DE); Karl Heinz JOHNEN, Aachen (DE); Dietmar OTTE, Berlin (DE); Norbert WEICHELE, Düsseldorf (DE); Jana Frederike CZERWTNSKE, Berlin (DE)

(21) Appl. No.: 18/713,340

(22) PCT Filed: Nov. 24, 2022
(86) PCT No.: PCT/EP2022/083153

§ 371 Date: May 24, 2024

(30) Foreign Application Priority Data
Nov. 25, 2021 (DE) 10 2021 130 963.8
Nov. 25, 2021 (DE) 10 2021 130 974.3
Nov. 25, 2021 (DE) 10 2021 130 977.8

(51) Int. Cl. A23L 15/00; A23L 29/20

(52) U.S. Cl. CPC A23L 15/35; A23L 15/25; A23L 29/20

(57) ABSTRACT

The invention relates to a vegan-based egg yolk substitute product containing a mixture of (a) drinking water, (b) one or more protein(s) from legumes, oil seeds, grains, algae, or microorganisms, (c) plant oil which optionally contains at least one emulsifier, (d) a combination of one or more reversibly thermogelling hydrocolloid(s) with one or more reversibly gelling hydrocolloid(s), (e) at least one carotenoid-containing food and/or a natural color-imparting substance, (f) optionally at least one partially pregelatinized starch, and (g) salt, wherein the proportion of the combination of one or more reversibly thermogelling hydrocolloid(s) and one or more reversibly gelling hydrocolloid(s) ranges from 0.5-5.00% by weight. The invention additionally relates to a method for producing the egg yolk substitute product and to the use of the egg yolk substitute product in the production of an emulsion or in a dish or a baked product or a simulated egg.

### FIELD OF THE INVENTION

The invention relates to a vegan-based egg yolk substitute product.

### BACKGROUND OF THE INVENTION

The awareness of the importance of a sustainable lifestyle also increases the importance of a purely plant-based diet. In addition to pure vegans and vegetarians, more and more people are trying to reduce the consumption of animal products (flexitarians and flexigans). The latter means that more and more plant-based foods are in demand and are also available, which offer consumers a similar taste experience to the corresponding animal products.

Eggs are a high-quality source of protein and, in addition to being consumed directly, they fulfill many tasks in food, such as the formation of emulsions and foams and the stabilization of dough masses. Due to the wide range of possible uses, a vegan alternative for eggs that covers as many areas as possible is a major challenge.

Chicken egg yolk is a fat-in-water emulsion and, in addition to just under 50% water, also contains around 30% fat, around 17% proteins, minerals and vitamins. Due to the high content of phospholipids (approx. 30% of the fat), egg yolk is a very good emulsifier, the carotenoids it contains lead to the characteristic yellow-orange color.

In the kitchen it is mainly used as an emulsifier (e.g. for mayonnaise), to loosen, foam and bind creams and to stabilize crumbs in baked goods. When heated above 72° C., the yolk solidifies.

WO 2017/014967 A1 and WO 2017/014806 A1 relate to plant-based egg substitute compositions which are characterized by a high content of hydrocolloids.

WO 2019/220431 A1 also relates to egg replacement compositions that have more than 5% hydrocolloids.

WO 89/10704 relates to an egg substitute in which the yolk substitute is surrounded by a membrane and coated with a natural egg white or a treated egg white or a Protein analogue is combined.

There are already various other egg yolk substitute products, the basis of which is mostly a mixture of starches and hydrocolloids, sometimes also of vegetable proteins (US 2013/0084361 A1; DE 603 13 732 T2). They can be used as dry or liquid products in food and there largely or partially take over the tasks of egg yolk (comparable color, binding). Some of these products also have a rheology comparable to animal egg yolk. If these foods are brought into contact with a light-colored, water-containing food (e.g. egg white or egg white substitute) for a period of more than 7 days, the yellow or orange color diffuses from the “yolk” into the “white”. Thus, egg yolk and egg white in free-flowing form are not storable next to each other without mixing. In addition, they do not have the characteristic domed shape of a fresh animal egg yolk.

### OBJECT OF THE INVENTION

The object of the present invention is to provide a vegan-based egg yolk-like food that can be brought into contact with another water-containing food for a period longer than 7 days without color equalization taking place, without the two Materials mix and without both or one of the two liquid phases solidifying. This food should be processed in the same way as animal egg yolk, i.e. it should form and stabilize emulsions and solidify when heated.

### BRIEF SUMMARY OF THE INVENTION

The object is achieved by an egg yolk substitute product, comprising a mixture of:
(a) drinking water
(b) one or more protein(s) from legumes, oilseeds, cereals, algae, or microorganisms,
(c) vegetable oil, which optionally contains at least one emulsifier
(d) a combination of one or more reversibly thermogelling hydrocolloid(s) with one or more reversibly gelling hydrocolloid(s)
(e) at least one carotenoid-containing food and/or a natural coloring substance,
(f) optionally an at least partially pregelatinized starch and
(g) salt,
wherein a proportion of the combination of one or more reversibly thermogelling hydrocolloid(s) with one or more reversibly gelling hydrocolloid(s) is 0.5-5.0% by weight.

The percentages given in the text below are in each case % by weight.

“Vegan-based” means that it contains no animal or animal-derived ingredients.

The product according to the invention advantageously has a protein content of between 1% and 35%, advantageously between 3% and 25% or 20%, very advantageously between 4% and 15% and particularly advantageously between 5% and 12%. Vegetable raw materials from the group of legumes, cereals, oilseeds, (micro)algae and microorganisms, advantageously peas (Pisum sativum), chickpeas (Cicer arientinum), haricot beans (Phaseolus vulgaris), faba beans (Vicia faba), sweet lupins are suitable as a protein source (Lupinus), lentils (Lens culinaris), corn (Zea mays), hemp (Cannabis sativa), sweet potatoes (Ipomoea batatas). cassava (Manihot esculenta), table potatoes (Solanum tuberosum), pumpkin (Cucurbita), flax (Linum usitatissimum), rapeseed (Brassica napus), soya (Glycine max), oats (Avena sativa), bacteria (e.g. Lactobacillus spp., Streptococcus spp., and Bifidobacterium spp.), yeasts (e.g. Saccharomyces cerevisiae), molds (e.g. Aspergillus spp., Mucor spp., and Rhizopus spp.), nori seaweed and/or wakame seaweed, pea, lupine, potato, chickpea and faba bean proteins are particularly advantageous. As a protein source (raw and/or hydrolyzed and/or fermented) flours, protein concentrates, protein isolates and/or any combination thereof, from the plants and plant parts per se, their seeds, tubers and/or their fruits of the aforementioned raw materials can be obtained, are used. The person skilled in the field of food technology is sufficiently familiar with the processing and nutritional suitability of the plants and respective plant parts.

In some embodiments, transglutaminases can optionally be added in order to improve the texture of the protein solutions or emulsions. The effect of transglutaminases on texture lies in their ability to promote cross-linking of proteins under certain temperature and time conditions. The amount of transglutaminases is advantageously between 0.001% and 3.00%, more advantageously 0.01%-1.5%, more advantageously 0.1%-1.0%. The transglutaminases are activated while the protein solution or emulsion is heated to temperatures between 40° C.-60° C. for at least 15 minutes, advantageously 30 minutes, 60 minutes, 90 minutes, or 120 minutes. The transglutaminase can, but need not, be microencapsulated and can advantageously be inactivated during manufacture of the egg replacement product by pasteurization or UHT treatment (above 75° C. or 120° C. respectively).

The fat content is advantageously between 1% and 50%, advantageously between 5% and 30%, very advantageously between 10% and 25% and particularly advantageously between 12% and 18%. Vegetable oils are suitable as the fat component, e.g. olive oil, coconut oil, linseed oil, walnut oil, safflower oil or peanut oil; however, tasteless fats such as rapeseed oil, sunflower oil, coconut fat and/or corn oil and any combination thereof are advantageous. Advantageously, up to 50%, advantageously 5-40%, more advantageously 10-30%, based on the proportion of the fat component, of emulsifiers can be added to the fat component. These are, for example, lecithin (or its components such as phosphatidylcholine, phosphatidylserine, phosphatidylethanolamine or phosphatidylinositol), ascorbyl palmitate, sodium phosphate, sodium pyrophosphate, potassium phosphate, propylene glycol alginate, polyoxyethyl stearate, ammonium phosphatide, acetic acid monoglycerides, lactic acid monoglycerides, citric acid monoglycerides, tartaric acid monoglycerides, stearyl tartrate or sorbitan monostearate.

In order to give the egg yolk substitute the right color, at least one foodstuff containing carotenoids and/or natural colorings are added as a further ingredient. Suitable for this are preparations made from fruits, vegetables, and tubers, advantageously from tuber and root vegetables, for example from carrots, apricots, tomatoes, peppers, pumpkin, fennel and/or sweet potatoes. These are advantageously boiled and mashed or finely chopped. In some embodiments, the amount of carotenoid-containing foods in the yolk is less than 15.0% (e.g., less than 12.0%, less than 8.00%, less than 4.00%, less than 2.00%, less than 1.50% or less than 0.50%). In some embodiments, the amount of carotenoid-containing foods in the yolk is 0.01%-10.0% (e.g. 0.50%-9.50%, 2.50%-7.50% or 3.00%-5.50%). It was found that the use of sweet potatoes as a food containing carotenoids surprisingly leads to the formation of a texture and color similar to the classic chicken egg yolk, with the use of sweet potatoes also supporting the protein content and fiber content and bringing a starch component into the mixture, which is advantageous affects the texture These are advantageously cooked and mashed or finely chopped. The amount of sweet potatoes can be between 3% and 10%, advantageously between 5% and 8%. If sweet potato is included as a carotenoid-containing food, the further addition of an at least partially pregelatinized starch is unnecessary (0%) or can be limited to a small amount of less than 0.5%. Otherwise, the addition of at least one (partially) pregelatinized starch is advisable, advantageously in an amount of 0.5%-4%, more advantageously 1.0%-3.0%. (Partially) pregelatinized starch is advantageously obtained from corn starch, potato starch or rice starch by mechanical processing in the presence of water with or without the application of heat. Some or all of the starch granules burst. The powder is then dried. Pregelatinized starch is a white to off-white powder and swells in cold water. It has good flow properties and is suitable as a binder.

Other suitable fruit, vegetable and tuber preparations can be used to adjust texture, mouthfeel, and color. The addition of advantageously fat-soluble natural dyes such as carotenoids (e.g. ß-carotene, lycopene, zeaxanthin), carrot extracts, curcumin and dyes that are sparingly soluble in water such as riboflavin is also suitable for optimum color adjustment. These are used individually or in combination to achieve the desired shade. In some embodiments, the amount of natural coloring in the yolk is less than 2.00% (e.g., less than 1.50%, less than 1.00%, less than 0.75%, or less than 0.25%) In some embodiments, the amount of natural coloring in the yolk is 0.01%-2.00% (e.g. 0.25%-1.75%, 1.00%-0.50% or 1.75%-0.25%). The yolk color can range from yellow to dark orange in the L*a*b* color space. The lightness (L*) can range from 70-85, advantageously from 75-80; the red-green (a*) can range from 15-30, advantageously from 19-25; the yellow-blue (b*) can be 60-95, advantageously 70-90, particularly advantageously be 75-88.

Salt is added to create a chicken egg-like flavor. Advantageously NaCl, KCl, NaH₂PO₄, Na₂HPO₄, Na- or K-citrate, CaCl₂, Na₃PO₄ and/or Kala-Namak (black salt) or a salt comparable to Kala-Namak which has a proportion of sulfur compounds. To this end, in some embodiments the amount of salt, advantageously Kala-Namak salt, is less than 2.00%, e.g. less than 0.75%, less than 0.50%, less than 0.25%, or less than 0.10%.

The egg yolk substitute may further contain minor amounts (less than 10.0%, advantageously less than 5%, 3% or 2%) of additional minor components. This can be flavor formulations, spices, dried vegetables or fruits, sugar, preservatives, thickeners, or health-promoting additives. Examples include iodine, vitamins (e.g. vitamin B₁, B₂, B₃, B₅, B₇, B₉, B₁₂, C, D₃ or E) and/or minerals (e.g. Ca or Mg).

The egg yolk substitute contains hydrocolloids to set the desired viscosity and solidify when heated. A combination of one or more thermogelling hydrocolloids with one or more reversibly gelling hydrocolloids has proven advantageous, with the two types differing in their behavior with temperature changes. The hydrocolloids, which quickly gel when the temperature is increased to >40° C., are called “thermogelling” or “thermo-reversible gelling” and are advantageously modified celluloses, advantageously methylcelluloses, hydroxyethyl celluloses, hydroxypropyl methylcellulose (HPMC) and/or hydroxypropyl cellulose. However, the resulting gelation is only temporary: when it cools down to <40°, the gel changes back into the original viscous solution. To produce the thermogelation, a specific minimum concentration of the thermogelling hydrocolloids should be present, which is about 1.5 g/l for methylcellulose. The person skilled in the art can determine the minimum concentration for other thermogelling hydrocolloids without great experimental effort. Below this concentration, no gelation occurs when the aqueous solution is heated. Reversibly gelling hydrocolloids form gels at room temperature (approx. 20° C.) which—in contrast to thermogelling hydrocolloids—melt when heated within a certain temperature interval, i.e. liquefy, and form a viscous solution which, in turn, after cooling to or below the gelling temperature gels again. Gels from algae, advantageously carrageenan and/or agar are used as reversibly gelling hydrocolloids. Other hydrocolloids, advantageously gellan gum, locust bean gum, guar gum, alginate and/or xanthan gum, are also used to set the desired consistency and support the lasting firmness of the vegan egg yolk. In some embodiments, the amount of hydrocolloids in the egg yolk replacement product is less than 5.00% (e.g., less than 4.75%, 4.50%, 4.25%, 4.00%, 3.75%, 3.50%, 3.25%, 3.00%, 2.75%, 2.50%, 2.25%, 2.00%, 1.75%, 1.50%, 1.00%, 0.75% or equal or less than 0.50%). In some embodiments, the amount of hydrocolloids in the egg yolk replacement product is 0.10%-4.5% (e.g. 0.20%-4.00%, 0.25%-3.00%, 0.50% %-2.50% or 0.75%-2.00%). The split between thermogelling and reversibly gelling hydrocolloids is advantageously 50:50, advantageously 25:75, 30:70 or 40:60 or 75:25, 70:30 or 60:40. A level of hydrocolloids less than 5.00% allows providing a liquid raw egg substitute, but on the other hand provides stability and texture comparable to a hen's egg when cooked.

In an advantageous embodiment, the egg yolk substitute mixture is enveloped by a shell of a highly crosslinked hydrocolloid or thermoreversibly gel-forming hydrocolloid, advantageously calcium alginate or k-carrageenan.

According to the invention, the protein source is dispersed in water or an aqueous salt solution (solution (A)). Solution (A) can be divided into two parts ((A1) and (A2)). However, it is also possible to prepare two solutions (A1) and (A2) independently of one another: (A1) can be an aqueous protein or protein-salt solution and (A2) that of another protein or just water. Optionally, 0.001%-2.00% transglutaminase can be added to solution (A1). If unencapsulated transglutaminase is used, the solution should be kept at 50° C. for less than 120 minutes. Solution (B) is prepared by heating solution (A1) to at least 40° C., advantageously 50° C. but not more than 60° C., and adding one or more thermogelling hydrocolloids (e.g. modified cellulose, methyl cellulose and/or hydroxypropyl cellulose) manufactured. The effect of heat improves the dispersion of the hydrocolloids. Before or after dispersion of the hydrocolloids, oil (possibly containing 0.01%-50% emulsifiers), if necessary a source of calcium ions, foodstuffs containing carotenoids or natural colorings and if necessary further additives are mixed in solution (B). Solution (C) is prepared by mixing solution (A2) with one or more reversible gelling hydrocolloids at a temperature below 30° C., advantageously less than 20° C., 15° C. or 10° C. In addition, natural flavorings, Aroma formulations, oil and (encapsulated) transglutaminase or other additives are mixed in solution (C). Once all components of solutions (B) and (C) are fully dispersed, solutions (B) and (C) are mixed at a temperature advantageously below 30° C., resulting in the final egg yolk solution (solution (D)). The solutions and dispersions described above are prepared in standard mixing vessels using known dispersion techniques.

The mixture (solution (D)) can be homogenized to achieve a complete and fine distribution of the oil particles. Surprisingly, this improved both the mouthfeel, so that roughness was no longer perceptible on the tongue, and the brightness, so that fewer dyes were needed for coloring and that the product had a higher gloss. Pressures between 5 bar and 300 bar can be used for the homogenization, better between 25 bar and 225 bar and especially well between 50 bar and 250 bar. The homogenization can be in one or two stages.

The independent solutions and their mixing are advantageously, but not necessarily, carried out under vacuum treatment. The vacuum can prevent air bubbles from forming in the yolk.

According to the invention, each of the solutions ((A), (B), (C) and/or (D)) can be either pasteurized or sterilized. Pasteurization/sterilization can also be complemented by other techniques such as UV and/or high-pressure processing. These procedures are standard techniques that are well within the skill of the art and are amply described in the literature.

Solution (D) can be used as a liquid (e.g. as an ingredient in food/bakery preparation or for a scrambled egg), or it can be formed into a spherical shape for use as a normal egg application for fried, scrambled, or hard-boiled eggs use. The following three methods are advantageously suitable for sphere formation.

### Method 1

For sphere formation (encapsulation), a soluble calcium salt (e.g. calcium lactate or calcium chloride) as part of the ingredients in solution (B) and/or (C) and the solution (B) and/or (C) is further processed as described above to give solution (D). The solution (D) containing the calcium salt should be dosed as spherically as possible into an aqueous solution of a highly crosslinking hydrocolloid, advantageously sodium alginate, and with this solution for a maximum of 5 minutes, advantageously less than 4 minutes and more advantageously remain in contact for less than 3 minutes to keep the filling (solution (D)) liquid. Solution (D) can be frozen or partially frozen in spherical forms beforehand and then added to a lukewarm bath of the highly crosslinking hydrocolloid to form capsules. Diffusion of calcium ions from the solution (D) into the solution of the highly cross-linked hydrocolloid forms an outer shell and encapsulates the egg yolk (=solution (D)) through a cross-linking reaction of the highly cross-linked hydrocolloid with the calcium ions. In other words, a surface layer forms around the solution (D), creating a shape that closely resembles a well-known animal egg yolk. The encapsulated yolk should be rinsed with water as soon as possible to stop the cross-linking reaction. The amount of hydrocolloid surrounding the solution (D) is no more than 1% of the total weight of the encapsulated yolk.

In an advantageous embodiment of method 1, the liquid “egg yolk” (solution (D)) is poured into a hydrocolloid (advantageously: sodium alginate) solution as a spherical, coherent body (weight: between 5 and 20 g) using a nozzle in a hydrocolloid (advantageously sodium alginate) solution and brought into contact with this solution for a period of less than 300 seconds, advantageously less than 240 seconds, 120 seconds, or 60 seconds. The encapsulated yolk can then be rinsed in a demineralized water bath to remove excess alginate so that the ‘yolk’ does not harden during storage and remains liquid on the inside. Surprisingly, the liquid product remains so stable in its encapsulation that it can be transferred intact to a bowl/pan so that it remains cambered and the liquid content only runs out after stirring/deliberate destruction of the shell.

### Method 2:

For sphere formation (encapsulation), a highly cross-linked Hydrocolloid (e.g. sodium alginate) introduced as part of the ingredients in solution (B and/or C) and the solution (B and/or C) is processed further as described above for solution (D). The solution (D) containing the highly crosslinking hydrocolloid should be dosed as spherically as possible into an aqueous calcium salt (e.g. calcium lactate or calcium chloride) solution and remain in contact with this solution for a maximum of 5 minutes, advantageously less than 4 minutes and even better less than 3 minutes, so that the filling (solution (D)) remains liquid. Solution (D) can be pre-frozen or frozen into spherical shapes and then placed in a lukewarm calcium salt bath to form capsules. By diffusion of calcium ions from the Calcium salt solution an outer shell forms and encapsulates the yolk (=solution (D)) through a crosslinking reaction between the highly crosslinked hydrocolloid and the calcium ions. In other words, a surface layer forms around the solution (D), creating a shape that closely resembles a well-known animal egg yolk. The encapsulated yolk should be rinsed with water as soon as possible to stop the cross-linking reaction. Surprisingly, the liquid product remains so stable in its encapsulation that it can be transferred intact to a bowl/pan so that it remains cambered and the liquid content only runs out after stirring/deliberate destruction of the shell. The amount of calcium salt surrounding the solution (D) is no more than 1% of the total weight of the encapsulated yolk.

### Method 3

For the formation of a spherical shape, the described egg yolk formulation (solution (D)) is deep frozen in suitable molds made of silicone rubber, plastic, stainless steel or similar at temperatures <0° C., typically at −18° C. and lower. The spheres or hemispheres obtained from frozen solution D with diameters between 1 and 4 cm, ideally around 2-3 cm, are then further cooled using liquid nitrogen (boiling point −196° C.) until no noticeable gas bubbles form on the surface of the spheres (reaching thermodynamic equilibrium) any more. A previously prepared solution of a thermoreversibly gelling hydrocolloid, typically sodium alginate and/or k-carrageenan, is dissolved in water at temperatures above 35° C. to obtain a 1-2% clear solution. This solution is then cooled down to temperatures between 35° C. and 50° C., ideally in the range of 45-50° C. The deep-frozen balls of solution D are then immersed in the hydrocolloid solution so that a gel layer forms on the surface as a result of cooling. The thickness of the gel layer can be adjusted by immersion time, bead size and amount of hydrocolloid solution supplied, and is 1-5 mm, typically around 1-2 mm. In other words, a surface layer forms around the solidified solution (D), resulting in a shape closely resembling a well-known animal egg yolk as a whole. Surprisingly, after thawing, the liquid product remains so stable in its encapsulation that it can be transferred intact to a bowl/pan, so that it remains there in a cambered shape and the liquid content only runs out after stirring/destroying the shell. The amount of thermoreversibly gelling hydrocolloid surrounding the solution (D) is not more than 1% of the total weight of the encapsulated yolk.

### Method 4

For the formation of a spherical shape, the described egg yolk formulation (solution (D) without calcium ion source) is deep frozen in suitable molds made of silicone rubber, plastic, stainless steel or similar at temperatures <0′C, typically at −18° C. and lower. If necessary, the spheres or hemispheres obtained from the frozen solution (D) with diameters between 1 and 4 cm, ideally around 2-3 cm, are then further cooled using liquid nitrogen (boiling point −196° C.) until no noticeable gas bubble development (reaching thermodynamic equilibrium) on the surface of the spheres takes place any more. The surface of the spheres or hemispheres can be sprayed with calcium ions so that the ions adhere to the frozen surface. A previously prepared solution of a thermoreversibly gelling hydrocolloid, typically sodium alginate and/or k-carrageenan, is dissolved in water at temperatures above 35° C. to obtain a 1-3% clear solution. This solution is then cooled down to temperatures between 35 and 50° C., ideally in the range of 45-50° C. The deep-frozen spheres, which ideally have a homogeneous layer of calcium ions on the surface, are then immersed in the hydrocolloid solution so that a gel layer forms on the surface as it cools. The thickness of the gel layer can be adjusted by immersion time, bead size and amount of hydrocolloid solution supplied, and is 1-5 mm, typically around 1-2 mm. In other words, a surface layer forms around the solidified solution (D), resulting in a shape closely resembling a well-known animal egg yolk as a whole. Surprisingly, after thawing, the liquid product remains so stable in its encapsulation that it can be transferred intact to a bowl/pan so that it remains curved and the liquid content only runs out after stirring/destroying the shell. The amount of thermoreversibly gelling hydrocolloid surrounding the solution (D) is not more than 1% of the total weight of the encapsulated yolk.

The encapsulated yolk can be stored in a preservative and/or buffer solution containing, for example, NaCl, calcium salt, benzoic and/or ascorbic acid.

The optimum amount of water depends to some extent on the precise composition of the egg yolk substitute. This can easily be determined by first mixing in a relatively small amount of water. If the liquid egg yolk substitute is even thicker than desired, more water can be mixed in. Thus, the viscosity of the egg yolk substitute is controlled by the addition of water to the aforementioned ingredients. The egg yolk substitute can have an initial viscosity (prior to any heat or other treatment), defined as the resistance to deformation at a given shear rate, in the range between 0.5 Pa·s and 200.0 Pa·s, advantageously 0.7 Pa·s˜150 Pa·s; 1.51 Pa·s˜100 Pa·s or 50 Pa·s˜80 Pa·s. On the other hand, after heat treatment (e.g. cooking), the yolk can have a viscosity in the range 100 Pa·s and 10,000 Pa·s, advantageously 300 Pa·s˜8,000 Pa·s, 700 Pa·s˜3,500 Pa·s or 900 Pa·s˜1,500 Pa·s. The viscosity can be measured using a rheometer (MCR301 SN802801740, Anton Paar GmbH, Graz, Austria) with a cylindrical measuring system (CC27-SN 12031) with a measuring gap d=1.136 mm become. A person skilled in the art knows how to carry out the viscosity measurement using a rheometer. Only exemplary conditions are described below. The cylinder is filled with e.g. 15 ml of the sample. The sample is equilibrated for 5 minutes at 10° C. and left for the measurement. The rotation is increased linearly from 2-100 s⁻¹ within 60 s. The rotation from 100 s⁻¹ is held for 30 s before reversing from 100-2 s⁻¹ over 60 s. For a given type and concentration of protein, the viscosity is adjusted by adding water, hydrocolloids, salt, and buffer salts and is carried out experimentally by measuring the viscosities.

The cooked yolk may have a firm texture, the hardness [N] being characterized by a breaking strength ranging between 150 g and 500 g, e.g. B. 200 g-450 g, 250 g-400 g or 300 g-350 g. The breaking force can be determined, for example, using a texture analyzer with evaluation software from Stable Micro Systems (Godalming, UK). Exemplary conditions are: deformation of 50%, 5 kg load, cylindrical punch with a diameter of 40 mm, and a head speed of 10 mm/min.

A particularly advantageous embodiment of the present invention includes:

| | |
|---|---|
| sweet potato | 5.0-10.0% |
| protein source | 3.0-16.0% |
| e.g. Faba bean protein or | |
| pea protein | |
| thermogelling hydrocolloid | 0.5-2.0% |
| (e.g. HPMC) | |
| Reversibly gelling hydrocolloid | 0.5-2.0% |
| (e.g. carrageenan) | |
| Salt | 0.01-2.0% |
| Fat component containing emulsifier | 2.0-25% |
| if necessary (e.g. rapeseed oil) | |
| Secondary components, | 0.1-10.0% |
| (e.g. dyes, spices, etc.) | |
| Water balance | Rest (33.0-88.89%) |

Surprisingly, the egg yolk substitute can also be used to create an emulsion (e.g. mayonnaise), prepare food, stabilize a cake, simulate an egg yolk in a fried or boiled egg, and also by mixing with an egg white or egg white substitute, ideally in a ratio 1:3, a scrambled egg can be made.

The invention is described in more detail with reference to drawing figures, wherein

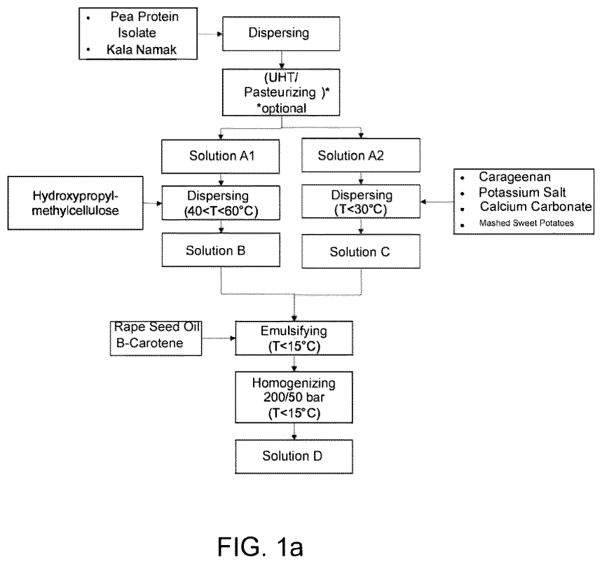

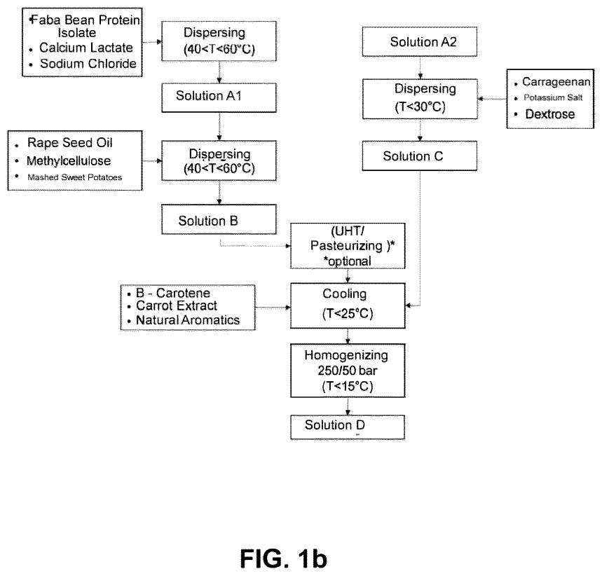

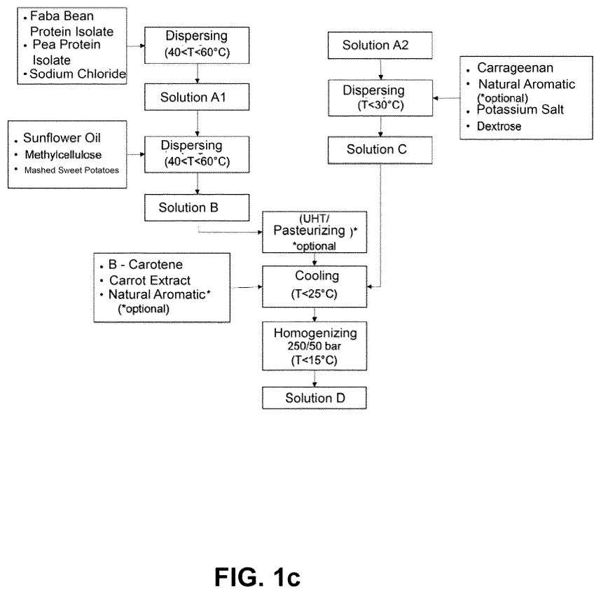

FIG. 1a illustrates a diagram for the production of an egg yolk substitute product according to embodiment 1;

FIG. 1b illustrates a diagram for the production of an egg yolk substitute product according to embodiment 2;

FIG. 1c illustrates a diagram for the production of an egg yolk substitute product according to embodiment 3; and

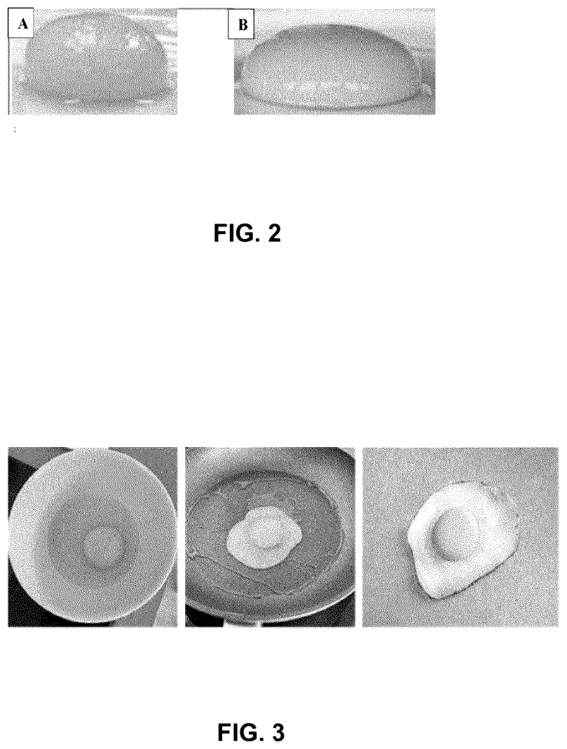

FIG. 2 illustrates a comparison of chicken egg yolk (A) with egg yolk substitute product according to the invention (B), wherein the egg yolk substitute is prepared according to the following recipe:

| | |
|---|---|
| Water | 76.04% |
| Sweet potato puree | 7.16% |
| Pea protein isolate | 8.00% |
| Methyl cellulose | 1.00% |
| Carrageenan | 1.00% |
| Calcium lactate | 2.00% |
| Potassium Chloride | 0.20% |
| Kala Namak | 0.60% |
| Xanthan Gum | 0.10% |
| Rapeseed oil | 3.00% |
| β-carotene | 0.90% |
| For encapsulation | |
| Sodium alginate in water | 0.65% |

FIG. 3 illustrates a preparation of a fried egg with egg yolk substitute product according to the invention.

Egg yolk substitute products according to the invention are described in the following embodiments. These descriptions do not represent a restriction to exactly these embodiments.

### EMBODIMENT 1

| | |
|---|---|
| Water | 67.28% |
| Mashed sweet potatoes | 5.49% |
| Pea Protein Isolate | 3.25% |
| Hydroxypropyl Methylcellulose | 1.00% |
| Carrageenan | 0.90% |
| Calcium lactate | 0.74% |
| Potassium Chloride | 0.10% |
| Kala Namak | 0.74% |
| Rapeseed oil 20.0% β-carotene | 0.50% |
| For encapsulation | |
| 0.75% sodium alginate solution | |

The production is performed as shown in the diagram of FIG. 1a.

### EMBODIMENT 2

| | |
|---|---|
| Water | 73.03% |
| Sweet potato puree | 6.00% |
| Faba bean protein isolate | 4.13% |
| Methylcellulose | 1.00% |
| Carrageenan | 1.00% |
| Dextrose | 0.10% |
| Calcium chloride | 0.25% |
| Potassium Chloride | 0.10% |
| Sodium Chloride | 0.03% |
| Rapeseed oil | 12.66% |
| β-carotene | 0.20% |
| Carrot Extract | 0.75% |
| Natural Flavor | 0.85% |
| For encapsulation | |
| 1.5% sodium alginate solution | |

The production takes place as shown in the diagram of FIG. 1b.

### EMBODIMENT 3

| | |
|---|---|
| water | 66.1% |
| Sweet potato puree | 6% |
| Faba Bean Protein Isolate | 3.25% |
| Pea Protein Isolate | 4.5% |
| Methyl cellulose | 1.2% |
| Carrageenan | 0.85% |
| Dextrose | 0.1% |
| Potassium Chloride | 0.1% |
| Sodium chloride | 0.1% |
| Sunflower oil | 15% |
| β-carotene | 0.2% |
| Carrot Extract | 0.75% |
| Natural Flavor 1 | 1% |
| Natural Flavor 2 | 0.85% |
| For encapsulation | |
| Sprayed calcium chloride on frozen balls (c.f. method 4) | |
| 1.0% warm (30 < T < 60° C.) sodium alginate solution | |

The preparation is performed as shown in the diagram of FIG. 1c.

1. A vegan-based egg yolk substitute product, comprising a mixture of:
(a) drinking water;
(b) one or more proteins from legumes, oilseeds, cereals, algae, or microorganisms;
(c) vegetable oil, optionally including at least one emulsifier;
(d) a combination of one or more reversibly thermogelling hydrocolloid(s) with one or more reversibly gelling hydrocolloid(s);
(e) at least one food product including carotenoids and/or a natural coloring substance;
(f) optionally at least one partially pregelatinized starch; and
(g) salt,
wherein a portion of the combination of the one or more reversibly thermogelling hydrocolloid(s) with the one or more reversibly gelling hydrocolloid(s) is 0.5-5.0% by weight.

2. The egg yolk substitute product according to claim 1, wherein the carotenoid-including food product includes sweet potato in an amount of 3.0-10.0% by weight.

3. The egg yolk substitute product according to claim 2, wherein no partially pregelatinized starch (f) is included in the mixture.

4. The egg yolk substitute product according to one of claims 1 to 3, wherein the mixture is enveloped by a shell of a highly crosslinked or thermoreversibly gel-forming hydrocolloid.

5. The egg yolk substitute product according to claim 4, wherein the shell is made from calcium alginate or k-carrageenan.

6. The egg yolk substitute product according to one of claims 1 to 5, wherein the mixture further includes a salt including sulfur-compounds or -salts.

7. The egg yolk substitute product according to one of claims 1 to 6, wherein the mixture further includes a spice or a flavoring formulation.

8. The egg yolk substitute product according to one of claims 1 to 7, wherein the hydrocolloid (d) is a combination of methyl cellulose and carrageenan.

9. The egg yolk substitute product according to one of claims 1 to 8, wherein the vegetable oil (c) is corn oil, rapeseed oil, coconut fat and/or sunflower oil or any combination thereof.

10. The egg yolk substitute product according to one of claims 1 to 9, wherein the vegetable protein (b) is pea protein, lupine protein, potato protein, chickpea protein and/or Faba bean protein.

11. The egg yolk substitute product according to one of claims 1 to 10, wherein the vegetable protein is a raw and/or hydrolyzed and/or fermented flour, protein concentrate, protein isolate and/or a combination thereof.

12. The egg yolk substitute product according to one of claims 1 to 11 having a protein content (b) between 1% by weight and 35% by weight.

13) The egg yolk substitute product according to one of claims 1 to 12, having a fat content (c) between 1% by weight and 50% by weight.

14) The egg yolk substitute product according to one of claims 1 to 13, wherein the vegetable oil (c) includes an emulsifier selected from lecithin, ascorbyl palmitate, sodium phosphate, sodium pyrophosphate, potassium phosphate, propylene glycol alginate, polyoxyethyl stearate, ammonium phosphatides, acetic acid monoglycerides, lactic acid monoglycerides, citric acid monoglycerides, tartaric acid monoglycerides, stearyl tartrate, or sorbitan monostearate.

15) The egg yolk substitute product according to one of claims 1 to 14, further comprising: transglutaminase, advantageously between 0.001 and 3.00% by weight.

16) A method for producing the egg yolk substitute product according to one of claims 1 to 15, the method comprising:
(a1) dispersing a vegetable protein in drinking water or in an aqueous saline solution to prepare a protein solution (A) and dividing the protein solution (A) into two parts (A1) and (A2); or
(a2) dispersing a plant protein in drinking water or in an aqueous common salt solution to produce a protein solution (A1) and a solution (A2) which contains either only drinking water or a second plant protein dissolved in drinking water;
(b) preparing a solution (B) by mixing the protein solution (A1) with a thermogelling hydrocolloid at least at 40° C.;
(c) preparing a solution (C) by mixing the protein solution (A2) with a reversibly gelling hydrocolloid at room temperature or at a temperature of up to 30° C.,
(d) mixing the solutions (B) and (C); and
(e) adding a vegetable oil optionally including an emulsifier under continuous stirring, a food product containing carotenoids and/or natural colorings and optionally other additives and optionally homogenizing to obtain a solution (D).

17) The method according to claim 16, wherein at least one salt is added to the solution (C).

18) The method according to claim 16 or 17, wherein the natural dye in step (e) is ß-carotene.

19) A use of the egg yolk substitute product according to one of the claims 1 to 15 for a production or as a component of an emulsion or a liquid including at least one phase, as an ingredient in a dish or a baked product or a simulated egg.

20) The use according to claim 19, wherein the component is a component of a vegan emulsion or a liquid including at least one phase, as an ingredient in a vegan dish or a vegan baked product.

21) The use according to claim 19, wherein the component is a component of a non-vegan emulsion or a liquid including at least one phase, as an ingredient in a non-vegan dish or non-vegan baked product.
